(19) United States
(12) Patent Application Publication
(10) Pub. No.: US 2022/0330521 A1
(43) Pub. Date: Oct. 20, 2022

(54) Wobble Slow Feeder

(71) Applicant: John J. Stone, Golden, CO (US)

(72) Inventor: John J. Stone, Golden, CO (US)

(21) Appl. No.: 17/231,999

(22) Filed: Apr. 15, 2021

(51) Int. Cl. A01K 5/02; A01K 15/02; A01K 5/01

(52) U.S. Cl. CPC A01K 5/0241; A01K 15/025; A01K 5/0114

(57) ABSTRACT

The invention comprises a novel wobble bowl with a labyrinthian maze top with channels directs treats or kibble through the channels when a pet tilts the feeder. The pattern of treats spreads out within the channels to slow the rate of consumption by the pet as it has to select the treats in an individual fashion and helps eliminate overeating and overly quick consumption.

### FIELD

The invention relates to a novel pet puzzle toy and feeder in which treats when placed travel a labyrinthian maze wherein a pet tips the dispenser (feeder) and treats travel through channels in the maze. The channels in the maze creates slower feeding as the pet has to pick each treat from sections of the maze versus having a full bowl of food that may be consumed quickly.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet toy and feeder that is designed to slow down food consumption by causing a pet to select treats from within a maze of sections, and wherein the bottom of the feeder is rounded so that the pet's contact causes the feeder to wobble spreading out treats even further within the maze.

It is well known in the animal behavior sciences dogs tend to eat food quickly and will consume more than they need. The inventive feeder is designed to slow consumption as well reacting as a toy when a dog interacts with the wobble feeder causing treats to move and alert the dog's senses.

### THE INVENTION

### Summary, Objects and Advantages

Typically pet owners have to measure food amounts so their pet does not overeat. Particularly with puppies and adult dogs. This can be an issue when an owner is away from the home for hours, but leaving large amounts of food freely accessed can allow overeating and cause health problems for the pet. The inventive feeder makes food kibble or treats last longer as well as entertain the pet.

With the inventive feeder, a solid bottom half is rounded so that the toy and dispenser will maintain movement in response to any manipulation from the pet, and treats will slide within the channels of the maze. Thus, the pet has to select individual treats or kibble versus getting large bites, eating too much, and eating too quickly. Affixed to the inside bottom of the base is a metal weight to aid as a center of gravity.

The top or maze portion twists off for easy cleaning as well as easy filling the feeder with treats.

Additionally, the sound of treats traveling through the maze portion adds interest for the pet and will ultimately remain in memory as a rewarding activity. The pet hears the treats in the maze and will remember that with manipulation, it can access treats or kibble from a maze channel.

### BRIEF DESCRIPTION OF THE DRAWINGS

The invention is described in further detail by reference to seven (7) drawings sufficient in detail to describe the invention in which:

FIG. 1 is a side perspective of the feeder;

FIG. 2 is top down perspective;

FIG. 3 is a magnified view of the tab for removing taking maze top;

FIG. 4 is a top-down view of the tab for removing the maze top;

FIG. 5 is a top-down perspective of the maze top;

FIG. 6 is a side perspective of the feeder; and

FIG. 7 is an exploded view showing the bottom weight.

### DETAILED DESCRIPTION, INCLUDING BEST MODES OF CARRYING OUT THE INVENTION

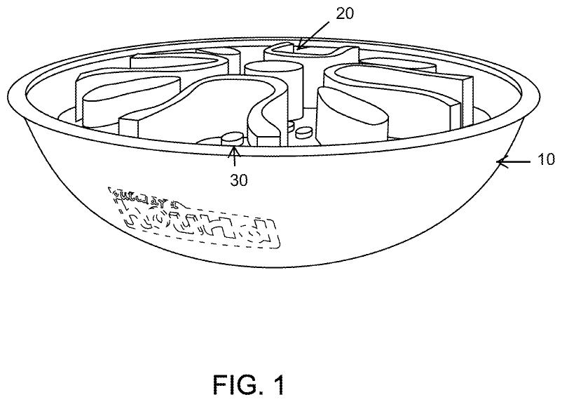

FIG. 1 illustrates the body of the toy and feeder with the rounded bottom 10 and the maze feature 20 as fits into the bottom piece. Additional obstructions 30 are created within the maze to add movement of treats or kibble into the maze channels. The movement either right or left of the circular obstructions is based on the direction the feeder is tilted. Treats or kibble will slide through the channels depending on the angle of tilt.

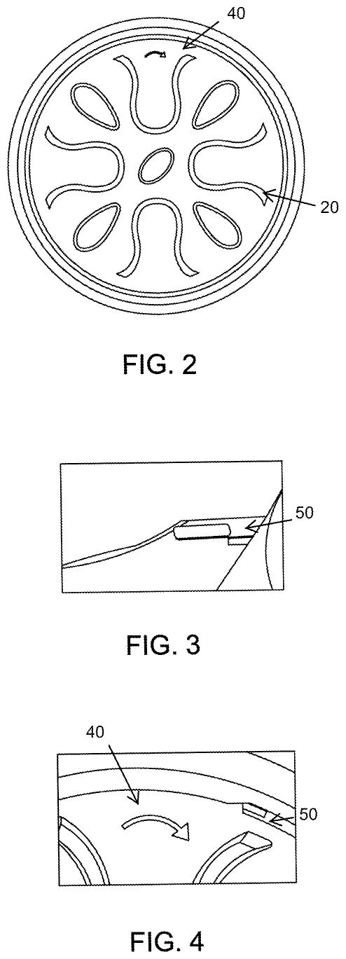

FIG. 2 is a top-down perspective of the feeder illustrating the general pattern of the maze 20. A directional indication 40 is shown on the top maze portion as will twist and remove from the base for cleaning or filling with treats or kibble. A tab and slot 50 mold creates means for keeping to top portion on or removing it by sliding the portion to the right to loosen. There are no apertures in the maze so that treats or kibble do not fall into the rounded bottom section.

FIG. 3 is a magnified view of the tab and slot 50 portion of the maze top which will release from the base piece by rotating to the right to loosen and left to reattach. When the feeder is tilted treats or kibble will travel via gravity through the channels. When obstructions as in FIG. 1 are present, the obstructions will further direct treats or kibble through a channel depending on angle of tilt of the feeder.

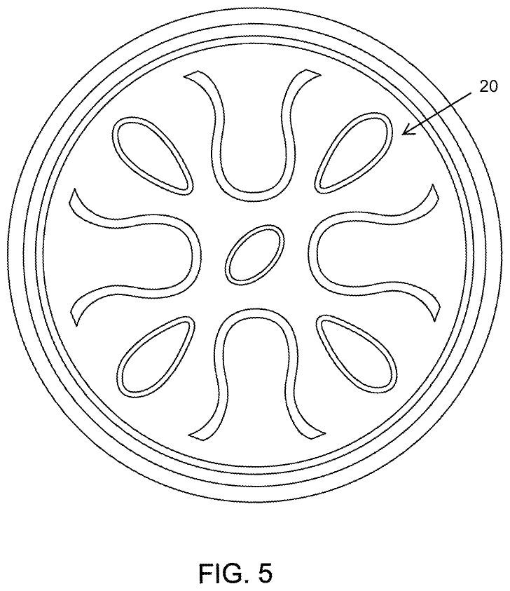

FIG. 4 is a magnified view of the directional arrow on the top maze piece 40 and the tab and slot portion 50.

FIG. 5 is a top-down perspective of the feeder showing the maze portion with channels 20 sans the directional obstructions. It is plain that the maze design may be altered to use any number of configurations that will allow treat or kibble travel through a channel when the feeder is tilted.

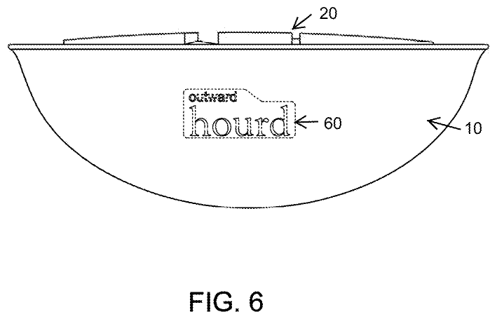

FIG. 6 is a side perspective of the feeder showing the base 10 and a side perspective of the top maze portion 20. In this embodiment the company name and logo 60 are molded into the base piece during manufacture.

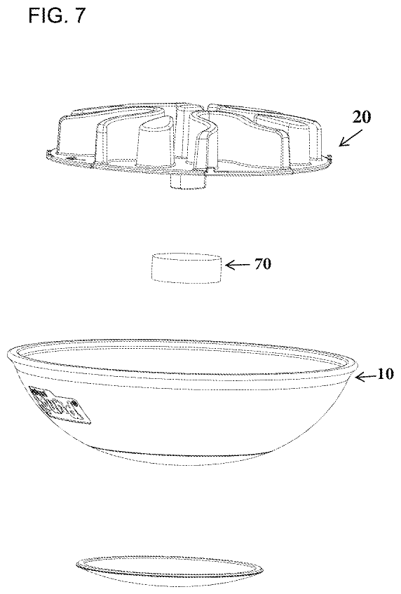

FIG. 7 is an exploded view of the feeder showing the metal weight 70 which is affixed to the inside bottom of the rounded base section 10. The weight creates a center of gravity so that the feeder will return to a level position when there is either no kibble or very little in the maze portion 20 of the feeder. The weight additionally reduces the distance the feeder may be moved or scooted by the pet.

1. A two-piece pet toy and feeder comprising;
a) a rounded bottom section with a circular metal weight affixed thereto
b) a removable top maze section with designed channels thereupon
c) a means for removing the top maze section
d) small obstructions within the maze channels

2. A two-piece pet toy and feeder as in claim 1 wherein the bottom section is a rounded base.

3. A two-piece pet toy and feeder as in claim 1 wherein the bottom section is hollow with the exception of a round metal weight affixed to the inside center of the bottom section.

4. A two-piece pet toy and feeder as in claim 1 wherein a removeable top section that snaps to the base piece and comprises a maze of channels wherein treats will travel via gravity depending on the direction the feeder is tilted by a pet.

5. A two-piece pet toy and feeder as in claim 1 wherein the top maze section is removable by sliding the top tab and slot to the right and releasing the top portion for cleaning or filling with treat or kibble.

6. A two-piece pet toy and feeder wherein small obstructions are placed within the maze channels so as to additionally direct treat or kibble either right or left through the maze channels in response to the angle of tilt of the feeder.
